(19) United States
(12) Patent Application Publication
(10) Pub. No.: US 2022/0327923 A1
(43) Pub. Date: Oct. 13, 2022

(54) OPTICAL FIBER SENSING SYSTEM, ROAD MONITORING METHOD, AND OPTICAL FIBER SENSING DEVICE

(71) Applicant: NEC Corporation, Minato-ku, Tokyo (JP)

(72) Inventors: Toshiaki TANAKA, Tokyo (JP); Shinichi MIYAMOTO, Tokyo (JP)

(73) Assignee: NEC Corporation, Minato-ku, Tokyo (JP)

(21) Appl. No.: 17/635,533

(22) PCT Filed: Aug. 26, 2019
(86) PCT No.: PCT/JP2019/033368

§ 371 Date: Feb. 15, 2022

(51) Int. Cl. G08G 1/01; G01H 9/00

(52) U.S. Cl. CPC G08G 1/0137; G01H 9/004

(57) ABSTRACT

An optical fiber sensing system according to the present disclosure includes: an optical fiber (10) provided along a road R to detect vibrations; a detection unit (21) configured to detect a vibration pattern of a vibration caused by a traffic accident that has occurred on the road R from optical signals received from the optical fiber (10); and an estimation unit (22) configured to estimate a situation of the traffic accident based on the vibration pattern.

### TECHNICAL FIELD

The present disclosure relates to an optical fiber sensing system, a road monitoring method, and an optical fiber sensing device.

### BACKGROUND ART

In recent years, a system for monitoring road conditions has been proposed. For example, Patent Literature 1 discloses a technique in which an impact sensor is fixed to a guard rail or the like on a road, and an accident detection signal indicating that a traffic accident has occurred is generated when the level of an electric signal output from the impact sensor is equal to or higher than a threshold level.

Further, Patent Literature 2 discloses a technique in which an optical fiber is laid on the surface of an underground power cable or the like to continuously detect whether or not a physical phenomenon has occurred in the optical fiber.

### CITATION LIST

### Patent Literature

Patent Literature 1: Japanese Unexamined Patent Application Publication No. 2000-227989
Patent Literature 2: Japanese Unexamined Patent Application Publication No. H06-307896

### SUMMARY OF INVENTION

### Technical Problem

However, the technique described in Patent Literature 1 can only detect whether or not a traffic accident has occurred on a road. The technique described in Patent Literature 2 can only detect whether or not a physical phenomenon has occurred.

Therefore, all of the techniques described in Patent Literatures 1 and 2 have a problem that the situation of a traffic accident that has occurred on a road cannot be grasped.

Therefore, an object of the present disclosure is to solve the above-mentioned problems and provide an optical fiber sensing system, a road monitoring method, and an optical fiber sensing device capable of grasping the situation of a traffic accident that has occurred on a road.

### Solution to Problem

An optical fiber sensing system according to one aspect includes:

an optical fiber provided along a road to detect vibrations;

a detection unit configured to detect a vibration pattern of a vibration caused by a traffic accident that has occurred on the road from optical signals received from the optical fiber; and an estimation unit configured to estimate a situation of the traffic accident based on the vibration pattern.

A road monitoring method according to one aspect includes:

allowing an optical fiber provided along a road to detect vibrations;

detecting a vibration pattern of a vibration caused by a traffic accident that has occurred on the road from optical signals received from the optical fiber; and

estimating a situation of the traffic accident based on the vibration pattern.

An optical fiber sensing device according to one aspect includes:

a detection unit configured to detect a vibration pattern of a vibration caused by a traffic accident that has occurred on a road from optical signals received from an optical fiber provided along the road to detect vibrations; and

an estimation unit configured to estimate a situation of the traffic accident based on the vibration pattern.

### Advantageous Effects of Invention

According to the above-described aspect, it is possible to provide an optical fiber sensing system, a road monitoring method, and an optical fiber sensing device capable of grasping the situation of a traffic accident that has occurred on a road.

### BRIEF DESCRIPTION OF THE DRAWINGS

FIG. 1 is a diagram showing a configuration example of an optical fiber sensing system according to a first example embodiment.

FIG. 2 is a diagram showing an example of vibration data used by the estimation unit according to the first example embodiment to estimate the situation of a traffic accident that has occurred on a road.

FIG. 3 is a diagram showing an example in which the estimation unit according to the first example embodiment estimates the situation of a traffic accident that has occurred on a road using pattern matching.

FIG. 4 is a diagram showing an example of vibration data used by the estimation unit according to the first example embodiment to estimate the situation of a traffic accident that has occurred on a road.

FIG. 5 is a diagram showing an example of vibration data used by the estimation unit according to the first example embodiment to estimate the situation of a traffic accident that has occurred on a road.

FIG. 6 is a diagram showing an example of vibration data used by the estimation unit according to the first example embodiment to estimate the situation of a traffic accident that has occurred on a road.

FIG. 7 is a diagram showing an example of vibration data used by the estimation unit according to the first example embodiment to estimate the situation of a traffic accident that has occurred on a road.

FIG. 8 is a diagram showing an example of a method in which the estimation unit according to the first example embodiment estimates the situation of a traffic accident that has occurred on a road.

FIG. 9 is a flowchart showing an operation example of the optical fiber sensing system according to the first example embodiment.

FIG. 10 is a diagram showing an example of vibration data used by an estimation unit according to a second example embodiment to estimate the situation of a traffic accident that has occurred on a road and an example of a traveling state of a vehicle on the road.

FIG. 11 is a diagram showing an example of vibration data used by the estimation unit according to the second example embodiment to estimate the situation of a traffic accident that has occurred on a road.

FIG. 12 is a flowchart showing an operation example of the optical fiber sensing system according to the second example embodiment.

FIG. 13 is a diagram showing a configuration example of an optical fiber sensing system according to a third example embodiment.

FIG. 14 is a diagram showing an example of a method in which the estimation unit according to the third example embodiment estimates the situation of a traffic accident that has occurred on a road.

FIG. 15 is a flowchart showing an operation example of the optical fiber sensing system according to the third example embodiment.

FIG. 16 is a diagram showing a configuration example of an optical fiber sensing system according to another example embodiment.

FIG. 17 is a diagram showing a configuration example of an optical fiber sensing system according to another example embodiment.

FIG. 18 is a diagram showing a configuration example of an optical fiber sensing system conceptually showing an example embodiment.

FIG. 19 is a flowchart showing an operation example of the optical fiber sensing system shown in FIG. 18.

FIG. 20 is a block diagram showing an example of a hardware configuration of a computer that realizes the optical fiber sensing device according to the example embodiment.

### DESCRIPTION OF EMBODIMENTS

Hereinafter, example embodiments of the present disclosure will be described with reference to the drawings. The following descriptions and drawings have been omitted or simplified as appropriate for the sake of clarification of the explanation. In the following drawings, the same elements are designated by the same reference signs, and duplicate explanations are omitted as necessary.

### First Example Embodiment

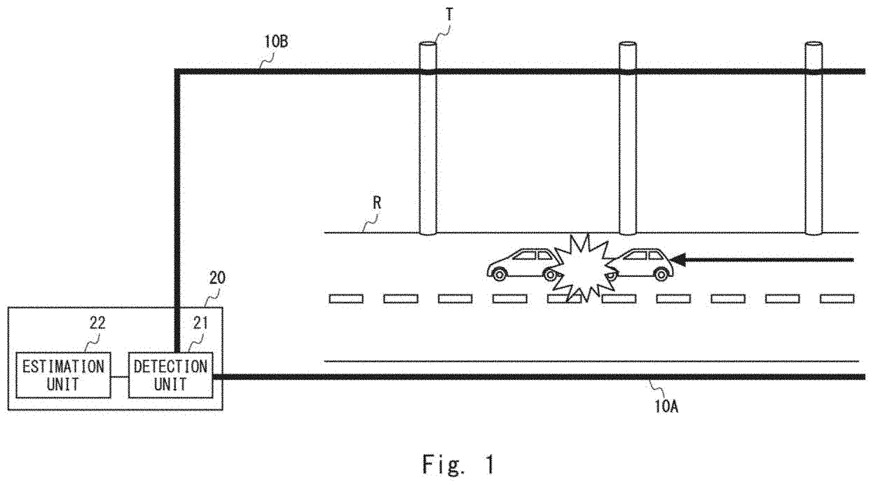

First, a configuration example of the optical fiber sensing system according to the first example embodiment will be described with reference to FIG. 1.

As shown in FIG. 1, an optical fiber sensing system according to the first example embodiment includes an optical fiber 10A (first optical fiber), an optical fiber 10B (second optical fiber), and an optical fiber sensing device 20. The optical fiber sensing device 20 includes a detection unit 21 and an estimation unit 22.

The optical fibers 10A and 10B are laid on a road R. Specifically, the optical fiber 10A is buried in the vicinity of the road R, and the optical fiber 10B is overhead-wired along the road R. In FIG. 1, the optical fiber 10B is overhead-wired by a utility pole T, but may be overhead-wired by another means such as a steel tower. The optical fibers 10A and 10B may be realized by existing unused communication optical fibers (so-called dark fibers). The optical fibers 10A and 10B may be realized by existing communication optical fibers in use if a frequency different from the frequency used for communication in the existing communication optical fibers is used. The optical fibers 10A and 10B may be laid on the road R in the form of an optical fiber cable configured by coating optical fibers.

The detection unit 21 makes pulsed light (incident light) incident on the optical fiber 10A. The detection unit 21 receives the reflected light or scattered light generated when the pulsed light is transmitted through the optical fiber 10A as return light (optical signal) via the optical fiber 10A. Similarly, the detection unit 21 makes the pulsed light incident on the optical fiber 10B and receives the return light from the optical fiber 10B.

When an impact is generated on the road R, the vibration is transmitted to the optical fiber 10A buried under the road R, affects the return light transmitted by the optical fiber 10A, and propagates through the air as sound. The sound is transmitted to the optical fiber 10B which is overhead-wired along the road R, and affects the return light transmitted by the optical fiber 10B. Therefore, the optical fibers 10A and 10B can detect the vibration generated on the road R and the sound caused by the vibration.

In this way, the impact generated on the road R propagates as vibrations through the ground and sounds through the air, but since the optical fiber 10A can easily detect the vibrations propagating on the ground, the vibrations are mainly detected. Further, since the optical fiber 10B can easily detect the sound propagating in the air, the sound is mainly detected.

In the above explanation, the detection of vibration due to an impact of an accident or the like has been described, but the optical fiber 10A is not limited to this, and can detect the vibration generated when a vehicle normally travels on the road R.

Here, the vibration generated on the road R has a unique vibration pattern in which the strength of the vibration, the vibration position, the transition of the fluctuation of the frequency, and the like differ depending on the event that caused the vibration. For example, the vibration pattern of vibration caused by a traffic accident that has occurred on the road R is a pattern unique to the traffic accident.

Therefore, by analyzing the dynamic change of the vibration pattern of the vibration caused by the traffic accident that has occurred on the road R, it is possible to not only detect that the traffic accident has occurred on the road R, but also estimate the situation of the traffic accident that has occurred on the road R.

For example, the following can be considered as the situation of a traffic accident.
Number of vehicles that caused a traffic accident
Type of vehicle that caused a traffic accident (for example, automobile, motorcycle, and the like)
Types of traffic accidents (for example, spin accidents, rollover accidents, collision accidents, and the like)
Property damage (for example, damage to traffic lights)

Therefore, the detection unit 21 detects the vibration pattern of the vibration caused by the traffic accident that has occurred on the road R from the return light received from the optical fibers 10A and 10B. Here, the optical fiber 10A detects the vibration directly transmitted to the road R. Therefore, the detection unit 21 detects, for example, the vibration pattern of vibration caused by a traffic accident from the return light received from the optical fiber 10A. On the other hand, the optical fiber 10B detects vibration as a sound transmitted from the road R through the air. Therefore, the detection unit 21 detects, for example, the vibration pattern of vibration caused by a traffic accident from the return light received from the optical fiber 10B.

The estimation unit 22 estimates the situation of a traffic accident that has occurred on the road R based on the vibration pattern of the vibration caused by the traffic accident detected by the detection unit 21. At this time, as described above, the vibration pattern of the vibration detected by the detection unit 21 is a pattern unique to a traffic accident. Therefore, the estimation unit 22 estimates the situation of a traffic accident by analyzing the dynamic change of the vibration pattern of the vibration detected by the detection unit 21.

In the first example embodiment, the return light received from the optical fibers 10A and 10B may be analyzed in real time to estimate the situation of the traffic accident. Alternatively, the return light received from the optical fibers 10A and 10B or the vibration data obtained by converting the return light may be temporarily stored, and then the return light or the vibration data may be read out and analyzed to estimate the situation of a traffic accident.

The estimation unit 22 may estimate the occurrence time of the traffic accident based on the time when the return light in which the vibration pattern caused by the traffic accident is detected is received by the detection unit 21 from the optical fibers 10A and 10B.

The estimation unit 22 may estimate the occurrence position of the traffic accident (distances of the optical fibers 10A and 10B from the detection unit 21) based on the time difference between the time when the detection unit 21 makes the pulsed light incident on the optical fibers 10A and 10B and the time when the return light in which the vibration pattern caused by the traffic accident is detected is received by the detection units 21 from the optical fibers 10A and 10B. Specifically, the estimation unit 22 can measure the distances of the optical fibers 10A and 10B from the detection unit 21 to the occurrence position of the traffic accident based on the above time difference. At this time, if the estimation unit 22 stores in advance a correspondence table in which the distances of the optical fibers 10A and 10B and the positions (points) corresponding to the distances are correlated with each other, the estimation unit 22 can estimate the occurrence position (point) of the traffic accident using the correspondence table.

Next, in the following, a specific method in which the estimation unit 22 estimates the situation of a traffic accident that has occurred on the road R will be described.

(A) Method A

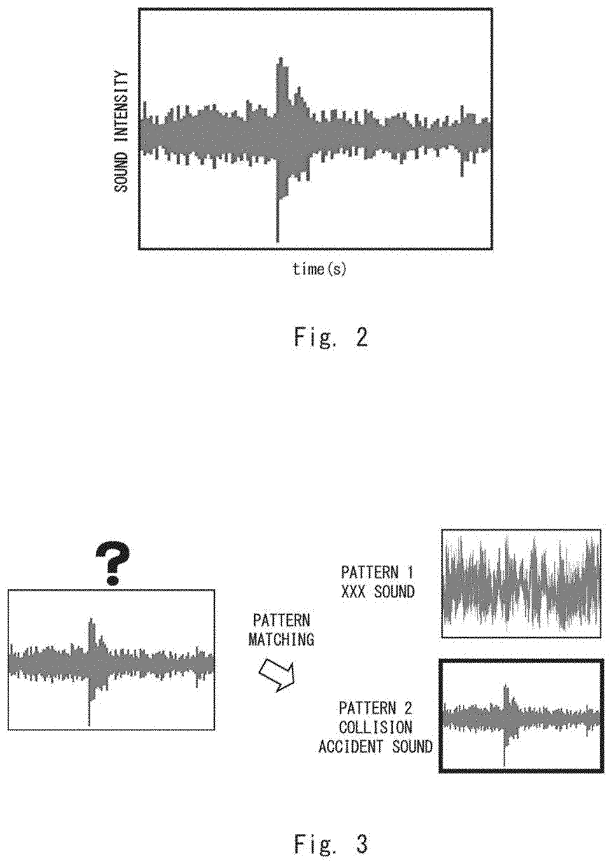

First, a method A for estimating the situation of a traffic accident that has occurred on the road R will be described with reference to FIGS. 2 and 3.

The detection unit 21 converts the return light received from the optical fiber 10B into vibration data as shown in FIG. 2, for example. The vibration data shown in FIG. 2 is vibration data of vibration detected by the optical fiber 10B at a certain position on the road R, and the horizontal axis indicates time and the vertical axis indicates sound intensity.

The estimation unit 22 estimates the situation of a traffic accident based on the vibration data as shown in FIG. 2. At this time, for example, the estimation unit 22 uses pattern matching. Specifically, the estimation unit 22 stores in advance vibration data corresponding to the situation of a traffic accident as teacher data. The teacher data may be learned by the estimation unit 22 by machine learning or the like. Then, as shown in FIG. 3, the estimation unit 22 compares the vibration pattern of the vibration data converted by the detection unit 21 with the vibration patterns of a plurality of pieces of teacher data stored in advance. When the vibration pattern of the vibration data converted by the detection unit 21 matches the vibration pattern of any of the teacher data, the estimation unit 22 determines that the vibration data converted by the detection unit 21 is the vibration data generated in the situation of the traffic accident corresponding to the matched teacher data. In the example shown in FIG. 3, the vibration data converted by the detection unit 21 has a vibration pattern substantially matching that of the vibration data at the time when a collision accident has occurred. Therefore, the estimation unit 22 determines that a collision accident has occurred.

(B) Method B

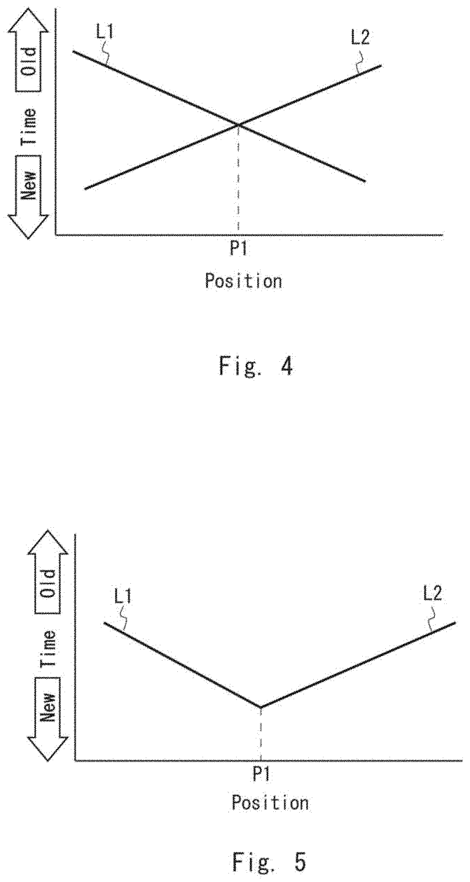

Next, a method B for estimating the situation of a traffic accident that has occurred on the road R will be described with reference to FIGS. 4 and 5.

The detection unit 21 converts the return light received from the optical fiber 10A into vibration data as shown in FIGS. 4 and 5, for example. The vibration data shown in FIGS. 4 and 5 is vibration data of vibration detected by the optical fiber 10A on the road R which is a single carriageway, and the horizontal axis indicates the distance of the optical fiber 10A from the detection unit 21 and the vertical axis indicates the passage of time. With respect to the vertical axis, data is older toward the positive direction.

In the vibration data shown in FIGS. 4 and 5, when the vibration of the vehicle traveling on the road R is detected by the optical fiber 10A, the traveling vehicle is represented by a line. For example, one vehicle traveling with the passage of time is represented by a single diagonal line. Here, the absolute value of the slope of the line represents the traveling speed of the vehicle. The smaller the absolute value of the slope of the line, the faster the traveling speed of the vehicle. The positive/negative of the slope of the line represents the traveling direction of the vehicle. For example, when a positive slope line represents a vehicle traveling in lane A, a negative slope line represents a vehicle traveling in lane B, which is the opposite lane of lane A.

The estimation unit 22 estimates the situation of a traffic accident based on the vibration data as shown in FIGS. 4 and 5.

In the example of FIG. 4, the line L1 has a negative slope, whereas the line L2 has a positive slope. This means that the vehicle represented by the line L1 is traveling in the opposite lane of the lane in which the vehicle represented by the line L2 is traveling. At this time, both vehicles continue to travel even after passing the position P1 where the distances of the optical fibers 10A from the detection unit 21 are the same. Therefore, in the example of FIG. 4, the estimation unit 22 determines that a traffic accident such as a collision does not occur and the vehicles pass each other normally.

On the other hand, in the example of FIG. 5, similarly to FIG. 4, the vehicle represented by the line L1 is traveling in the opposite lane of the lane in which the vehicle represented by the line L2 is traveling. However, both vehicles suddenly stop traveling without decelerating at the position P1 where the distances of the optical fibers 10A from the detection unit 21 are the same. Therefore, the estimation unit 22 determines that a head-on collision accident has occurred in the example of FIG. 5.

Also in this method B, the estimation unit 22 may estimate the situation of a traffic accident based on the vibration data as shown in FIGS. 4 and 5 using the same pattern matching as the above-mentioned method A.

(C) Method C

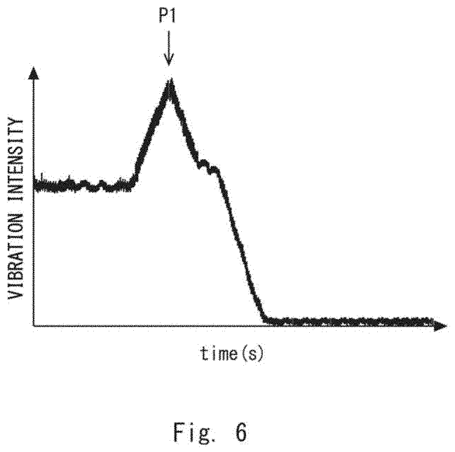

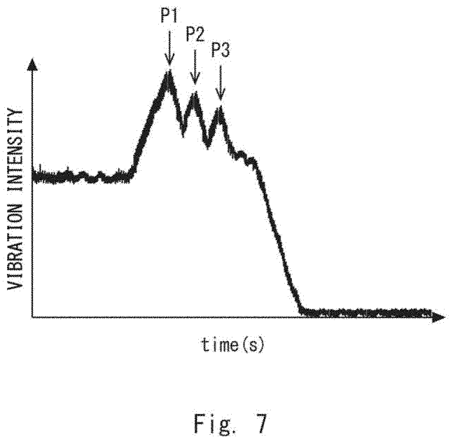

Next, a method C for estimating the situation of a traffic accident that has occurred on the road R will be described with reference to FIGS. 6 and 7.

The detection unit 21 converts the return light received from the optical fiber 10A into vibration data as shown in FIGS. 6 and 7, for example. The vibration data shown in FIGS. 6 and 7 focuses on a specific vehicle traveling on the road R, and shows the vibration data of the vehicle detected by the optical fiber 10A in chronological order.

The estimation unit 22 estimates the situation of a traffic accident based on the vibration data as shown in FIGS. 6 and 7.

In both the examples of FIGS. 6 and 7, a large peak P1 unique to a traffic accident occurs in the vibration data.

However, in the example of FIG. 6, one peak P1 is generated but the vibration is converged. From this, it is considered that the vehicle that caused the traffic accident once collided with something and stopped. Therefore, the estimation unit 22 determines that a relatively simple form of accident has occurred.

On the other hand, in the example of FIG. 7, after the peak P1 is generated, relatively large peaks P2 and P3 are also continuously generated. From this, it is considered that the vehicle that caused a traffic accident collides with another vehicle or the like, or rolls over, and the vibration at that time is generated as peaks P2 and P3. Therefore, the estimation unit 22 determines that a complicated form of collision accident such as a collision or a rollover of a plurality of vehicles has occurred. The estimation unit 22 may determine the number of vehicles in which a collision accident has occurred based on the number of peaks in the vibration data. In the example of FIG. 7, since three peaks P1 to P3 are generated, the estimation unit 22 determines that if the collision of the peaks P1 is a collision between vehicles, a collision accident by at least four vehicles has occurred.

Also in this method C, the estimation unit 22 may estimate the situation of a traffic accident based on the vibration data as shown in FIGS. 6 and 7 using the same pattern matching as in the above method A.

Here, the above-mentioned methods A to C are examples of estimating the types of traffic accidents (for example, single accidents, multiple collision accidents, and the like), the number of vehicles that caused a traffic accident, and the like. However, the present invention is not limited to these examples, and the estimation unit 22 may analyze the vibration pattern, and estimate the type of vehicle that caused the traffic accident (for example, automobile, motorcycle, and the like), property damage (for example, damage to traffic lights, and the like), and the like.

The estimation unit 22 may estimate the situation of a traffic accident using the above-mentioned methods A to C in combination with each other. In the above-mentioned methods B and C, the vibration directly transmitted to the road R is detected, whereas in the above-mentioned method A, the vibration is also detected as the sound transmitted from the road R through the air. Therefore, for example, the estimation unit 22 analyzes the collision sound according to the above-mentioned method A, and determines that there is a possibility of an injury accident that a vehicle collides with a person when it is determined that a dull collision sound other than the collision sound between metals is generated, and the time and position match the impact detected by the above-mentioned method C and the sudden deceleration position of the vehicle.

(D) Method D

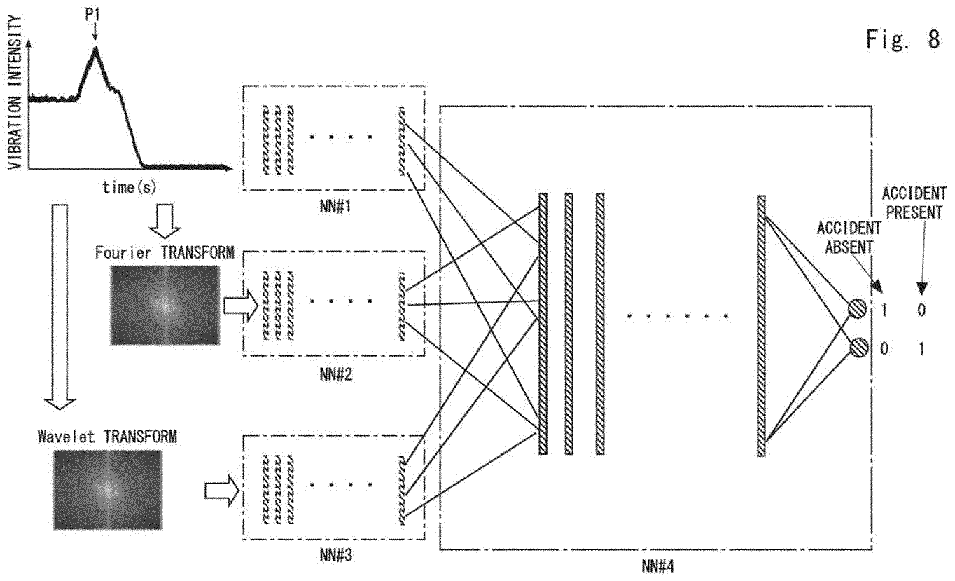

Next, with reference to FIG. 8, a method D for estimating the situation of a traffic accident that has occurred on the road R will be described.

In FIG. 8, a neural network (NN) to which vibration data representing a temporal change of amplitude as shown in FIGS. 6 and 7 is input is NN #1, an NN to which the spectrum after the vibration data is subjected to Fourier transform is input is NN #2, an NN to which the spectrum after the vibration data is subjected to Wavelet transform is input is NN #3, and an NN representing the fusion weight of NN #1 to NN #3 is NN #4.

The estimation unit 22 comprehensively determines the three types of information of NN #1 to NN #3 to estimate the presence or absence of the occurrence of a traffic accident.

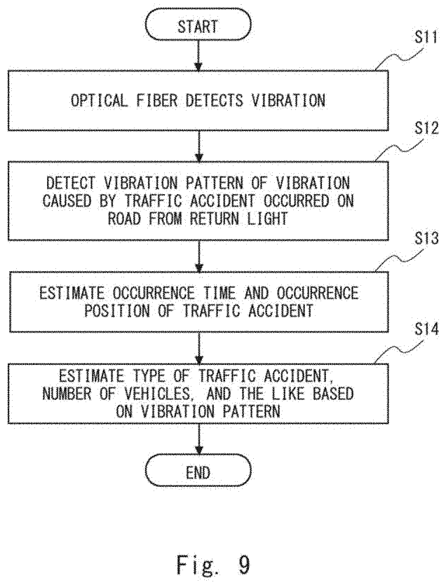

Next, an operation example of the optical fiber sensing system according to the first example embodiment will be described with reference to FIG. 9.

As shown in FIG. 9, the optical fibers 10A and 10B detect the vibration generated on the road R (step S11). The vibration detected by the optical fibers 10A and 10B affects the return light transmitted through the optical fibers 10A and 10B.

Next, the detection unit 21 detects the vibration pattern of the vibration caused by the traffic accident that has occurred on the road R from the return light received from the optical fibers 10A and 10B (step S12).

Next, the estimation unit 22 estimates the occurrence time of the traffic accident based on the time when the return light in which the vibration pattern caused by the traffic accident is detected is received from the optical fibers 10A and 10B. Furthermore, the estimation unit 22 estimates the occurrence position of the traffic accident based on the time difference between the time when the pulsed light is incident on the optical fibers 10A and 10B and the time when the return light in which the vibration pattern caused by the traffic accident is detected is received from the optical fibers 10A and 10B (step S13).

After that, the estimation unit 22 estimates the type of traffic accident (for example, single accident, multiple collision accident, and the like), the number of vehicles that have caused a traffic accident, and the like, as the situation of the traffic accident that has occurred on the road R, based on the vibration pattern of the vibration caused by the traffic accident that has occurred on the road R detected by the detection unit 21 (step S14).

As described above, according to the first example embodiment, the optical fibers 10A and 10B detect the vibration generated on the road R. The detection unit 21 detects the vibration pattern of the vibration caused by the traffic accident that has occurred on the road R from the return light received from the optical fibers 10A and 10B. The estimation unit 22 estimates the situation of a traffic accident that has occurred on the road R based on the vibration pattern. As a result, it is possible not only to grasp whether or not a traffic accident has occurred on the road R, but also to grasp the situation of the traffic accident that has occurred on the road R.

For example, if a microphone or a camera is arranged at an intersection, there is a possibility that a traffic accident can be detected from the impact sound collected by the microphone or the camera image photographed by the camera.

However, in this method, traffic accidents can only be detected at intersections where microphones and cameras are located.

In contrast, according to the first example embodiment, the optical fibers 10A and 10B can detect vibration at any of the places where the optical fibers 10A and 10B are laid. Therefore, it is possible to detect the occurrence of a traffic accident at any of the places where the optical fibers 10A and 10B are laid and grasp the situation of the traffic accident.

According to the first example embodiment, the optical fibers 10A and 10B may be realized by existing communication optical fibers. In this case, since it is not necessary to newly install the optical fibers 10A and 10B, the optical fiber sensing system can be constructed at a low cost.

According to the first example embodiment, the estimation unit 22 may estimate the occurrence time of the traffic accident based on the time when the return light in which the vibration pattern caused by the traffic accident is detected is received from the optical fibers 10A and 10B. In this case, since the exact occurrence time of the traffic accident can be grasped, it is possible to specify the revealed status of the traffic light at the occurrence time of the traffic accident. As a result, even if the party involved in the traffic accident perjuries the revealed status, it can be determined to be perjury.

According to the first example embodiment, the vibration data of the vibration detected by the optical fiber 10A and the vibration data of the vibration detected by the optical fiber 10B as sound are used in order to estimate the situation of the traffic accident that has occurred on the road R, but there is no limitation thereto. When there is a temperature change on the road R, the temperature change also affects the return light transmitted by the optical fibers 10A and 10B, so that the optical fibers 10A and 10B can also detect the temperature of the road R. Therefore, the detection unit 21 may convert the return light received from the optical fibers 10A and 10B into temperature data, and the estimation unit 22 may further use the temperature data to estimate the situation of a traffic accident. Using the temperature data, the estimation unit 22 can determine, for example, that the road R is frozen. The estimation unit 22 can determine, for example, that a fire or an explosion has occurred on the road R using the temperature data in combination with the vibration data. Therefore, for example, when the estimation unit 22 estimates a collision accident using vibration data, the estimation unit 22 can determine that the collision accident has occurred due to freezing of the road R, a fire or an explosion occurring on the road R, by further using the temperature data.

### Second Example Embodiment

An optical fiber sensing system according to the second example embodiment has the same configuration as that of the first example embodiment described above, but has expanded the functions of the detection unit 21 and the estimation unit 22.

The vibration pattern of the vibration generated on the road R also differs depending on the traveling state of the vehicle on the road R (for example, the traveling direction, the traveling speed, the number of traveling vehicles, the distance between vehicles, the presence or absence of traffic congestion, the presence or absence of dangerous driving, and the like). Vibration caused by the traveling state of the vehicle can be detected particularly by the optical fiber 10A buried under the road R.

In the second example embodiment, the situation of the traffic accident is estimated using not only the vibration pattern of the vibration caused by a traffic accident that has occurred on the road R but also the vibration pattern of the vibration caused by the traveling state of the vehicle on the road R.

As described above, the estimation unit 22 can specify the occurrence time and the occurrence position of the traffic accident that has occurred on the road R.

Therefore, the detection unit 21 further detects the vibration pattern of the vibration caused by the traveling state of a vehicle near the occurrence position of the traffic accident on the road R from the return light received from the optical fiber 10A at the occurrence time point of the traffic accident or at least before or after the occurrence of the traffic accident.

The estimation unit 22 estimates the situation of the traffic accident that has occurred on the road R based on the vibration pattern of the vibration caused by the traffic accident that has occurred on the road R detected by the detection unit 21 and the vibration pattern of the vibration caused by the traveling state of a vehicle near the occurrence position of the traffic accident on the road R at the occurrence time point of the traffic accident or at least before or after the occurrence of the traffic accident. At this time, as described above, the vibration pattern of the vibration detected by the detection unit 21 includes a pattern unique to the traffic accident and also includes a unique pattern corresponding to the traveling state of the vehicle on the road R. Therefore, the estimation unit 22 estimates the situation of a traffic accident by analyzing the dynamic change of the vibration pattern of the vibration detected by the detection unit 21.

In the second example embodiment, the return light received from the optical fibers 10A and 10B or the vibration data obtained by converting the return light is temporarily stored, and then the return light or the vibration data is read out and analyzed to estimate the situation of the traffic accident.

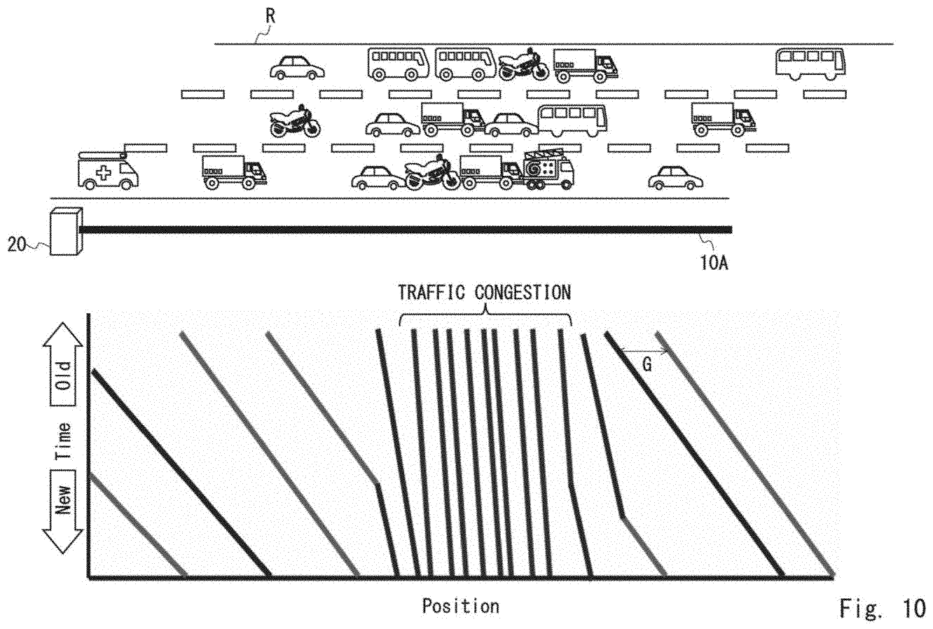

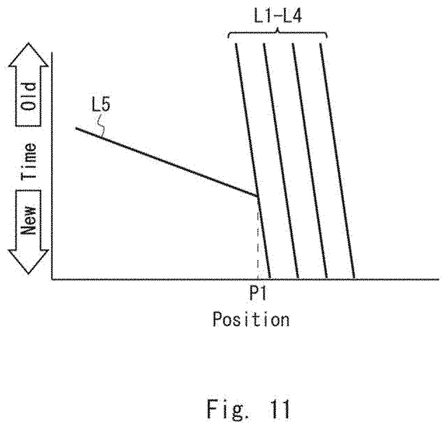

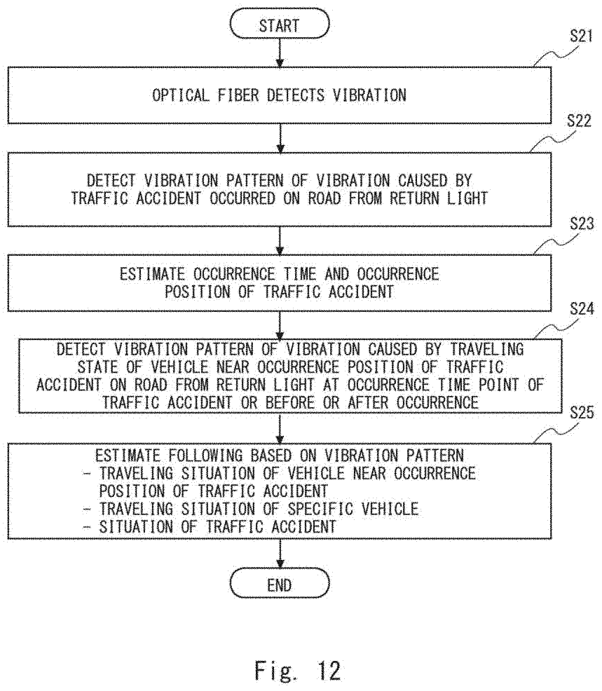

Next, with reference to FIGS. 10 and 11, a specific method in which the estimation unit 22 estimates the situation of a traffic accident that has occurred on the road R will be described below.

The upper figure of FIG. 10 shows the traveling state of a vehicle on the road R. Since the vibration caused by the traveling state of a vehicle is detected particularly by the optical fiber 10A, the illustration of the optical fiber 10B is omitted in the upper figure of FIG. 10.

The optical fiber 10A detects the vibration generated on the road R when the traveling state is as shown in the upper figure of FIG. 10, and the vibration affects the return light. The detection unit 21 receives the return light from the optical fiber 10A. The detection unit 21 converts the return light received from the optical fiber 10A into vibration data as shown in the lower figure of FIG. 10, for example.

The estimation unit 22 estimates the situation of a traffic accident based on the vibration data as shown in the lower figure of FIG. 10.

The horizontal axis and the vertical axis of the vibration data shown in the lower figure of FIG. 10 are the same as those shown in FIGS. 4 and 5. Therefore, even in the vibration data shown in the lower figure of FIG. 10, one vehicle traveling on the road R with the passage of time is represented by a single diagonal line. The absolute value of the slope of the line represents the traveling speed of the vehicle, and the positive/negative of the inclination of the line represents the traveling direction of the vehicle. The distance G in the horizontal axis direction of the line represents the distance between vehicles, and the shorter the distance G, the shorter the distance between vehicles.

In the vibration data shown in the lower figure of FIG. 10, the plurality of lines near the center have a negative slope and a large absolute value, and the distance G between the lines is also short. This means that a plurality of vehicles is traveling in the same traveling direction, but the traveling speed is slow and the distance between vehicles is short. Therefore, it is considered that traffic congestion has occurred. On the other hand, it is considered that there is no traffic congestion except near the center. In the example of the lower figure of FIG. 10, no traffic accident has occurred.

Next, the vibration data of FIG. 11 converted by the same method as the lower figure of FIG. 10 will be described. The vibration data shown in FIG. 11 is vibration data of vibration detected by the optical fiber 10A on the road R which is a single carriageway.

In the example of FIG. 11, the four vehicles represented by the lines L1 to L4 are traveling in the same traveling direction, but the traveling speed is slow and the distance between vehicles is short. Therefore, it is considered that traffic congestion has occurred. On the other hand, the vehicle represented by the line L5 is traveling in the opposite lane of the lane in which the four vehicles represented by the lines L1 to L4 are traveling. The vehicle represented by the line L5 has stopped traveling at the position P1 where it is considered that the traffic congestion has occurred. Therefore, in the example of FIG. 11, the estimation unit 22 determines that a traffic accident has occurred in which a vehicle from the opposite lane collides head-on with a row of vehicles in which traffic congestion has occurred.

In this method, the estimation unit 22 may estimate the situation of the traffic accident using the same pattern matching as the method A described in the above-described first example embodiment based on the vibration data as shown in FIG. 11 and the lower figure of FIG. 10.

In the above-mentioned method, it is estimated that the traffic congestion occurred on the road R based on the vibration data as shown in FIG. 11 and the lower figure of FIG. 10. However, the present invention is not limited to this example, and the estimation unit 22 may estimate, for example, the presence or absence of a vehicle that is driving dangerously (for example, aggressive driving, meandering driving, wrong-way driving, and the like), or the presence or absence of a vehicle that made a sudden brake. For example, the estimation unit 22 can determine that if there is a vehicle traveling in a direction different from the other vehicles on the road R which is one-way street, the vehicle is driving the wrong way. Further, if there is a vehicle continuously traveling at a short distance from the vehicle in front even though the vehicle is traveling at a speed equal to or higher than a threshold value, the estimation unit 22 can determine that the vehicle is driving aggressively. If there is a vehicle whose traveling speed has slowed down by a threshold value or more, the estimation unit 22 can determine that the vehicle is making a sudden brake.

In addition, the estimation unit 22 can also estimate that traffic congestion has occurred after the occurrence of a traffic accident, that there is a vehicle that has escaped from the occurrence position of the traffic accident using the vibration data after the occurrence of the traffic accident, and the like.

Next, an operation example of the optical fiber sensing system according to the second example embodiment will be described with reference to FIG. 12. As shown in FIG. 12, the optical fibers 10A and 10B detect the vibration generated on the road R (step S21). The vibration detected by the optical fibers 10A and 10B affects the return light transmitted through the optical fibers 10A and 10B.

Next, the detection unit 21 detects the vibration pattern of the vibration caused by the traffic accident that has occurred on the road R from the return light received from the optical fibers 10A and 10B (step S22).

Next, the estimation unit 22 estimates the occurrence time of the traffic accident based on the time when the return light in which the vibration pattern caused by the traffic accident is detected is received from the optical fibers 10A and 10B. Furthermore, the estimation unit 22 estimates the occurrence position of the traffic accident based on the time difference between the time when the pulsed light is incident on the optical fibers 10A and 10B and the time when the return light in which the vibration pattern caused by the traffic accident is detected is received from the optical fibers 10A and 10B (step S23).

Next, the detection unit 21 detects the vibration pattern of the vibration caused by the traveling state of a vehicle near the occurrence position of the traffic accident on the road R from the return light received from the optical fiber 10A at the occurrence time point of the traffic accident or at least before or after the occurrence of the traffic accident (step S24).

After that, the estimation unit 22 estimates the following based on the vibration pattern of the vibration caused by the traffic accident that has occurred on the road R detected by the detection unit 21 and the vibration pattern of the vibration caused by the traveling state of a vehicle near the occurrence position of the traffic accident on the road R at the occurrence time point of the traffic accident or at least before or after the occurrence of the traffic accident (step S25).
Driving conditions of vehicles near the occurrence position of a traffic accident on the road R (for example, the presence or absence of a traffic congestion and the like)
Driving conditions of a specific vehicle on the road R (for example, aggressive driving, meandering driving, wrong-way driving, and the like)
Situation of traffic accidents that occurred on the road R (for example, types of traffic accidents, number of vehicles that caused traffic accidents, and the like)

As described above, according to the second example embodiment, the detection unit 21 detects the vibration pattern of the vibration caused by the traffic accident that has occurred on the road R from the return light received from the optical fibers 10A and 10B, and detects the vibration pattern of the vibration caused by the traveling state of the vehicle near the occurrence position of the traffic accident on the road R from the return light received from the optical fiber 10A at the occurrence time point of the traffic accident or at least before or after the occurrence of the traffic accident. The estimation unit 22 estimates the situation of the traffic accident that has occurred on the road R based on those vibration patterns. As a result, it is possible to grasp the situation of the traffic accident that has occurred on the road R in more detail. Other effects are the same as those of the first example embodiment described above.

Also in the second example embodiment, the estimation unit 22 may further use the temperature data to estimate the situation of the traffic accident, as in the first example embodiment described above.

### Third Example Embodiment

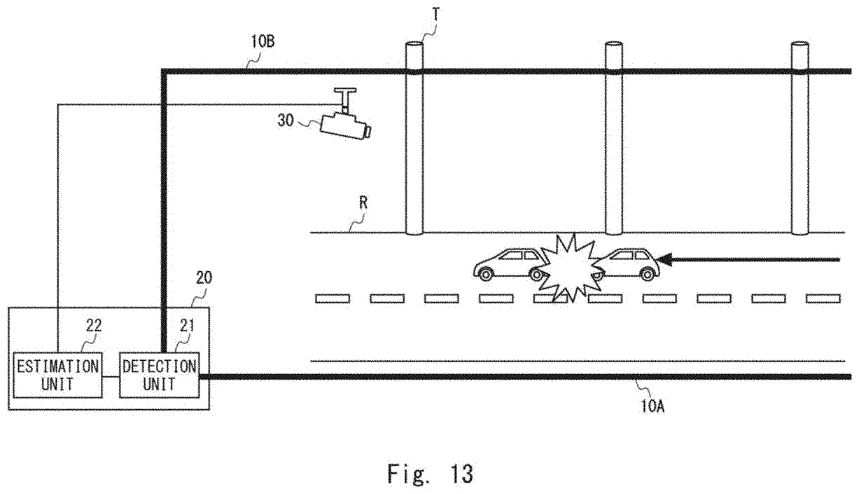

Next, a configuration example of an optical fiber sensing system according to the third example embodiment will be described with reference to FIG. 13. In the following description, the third example embodiment will be described as having a configuration in which a function is added to the first example embodiment described above, but naturally, the third example embodiment may have a configuration in which a function is added to the second example embodiment described above.

As shown in FIG. 13, the optical fiber sensing system according to the third example embodiment is different from the first example embodiment described above in that a camera 30 is added. Although only one camera 30 is provided in FIG. 13, a plurality of cameras 30 may be provided.

The camera 30 is a camera that photographs the road R, and is realized by, for example, a fixed camera, a PTZ (Pan Tilt Zoom) camera, or the like.

The estimation unit 22 stores camera information indicating the installation position of the camera 30 (distances of the optical fibers 10A and 10B from the detection unit 21, latitude and longitude of the installation position of the camera 30, and the like), the position (latitude and longitude, and the like) that defines the photographable area of the camera 30, and the like. Further, as described above, the estimation unit 22 can estimate the occurrence time and the occurrence position (distances of the optical fibers 10A and 10B from the detection unit 21) of the traffic accident that has occurred on the road R.

Therefore, when a traffic accident occurs in the photographable area of the camera 30 on the road R, the estimation unit 22 estimates the occurrence time and the occurrence position of the traffic accident. Then, the estimation unit 22 acquires a camera image near the occurrence position of the traffic accident at the occurrence time point of the traffic accident or at least before or after the occurrence of the traffic accident from the camera images photographed by the camera 30. However, in order to acquire a camera image near the occurrence position of the traffic accident, it is necessary to perform a process of converting the occurrence position of the traffic accident to the position on the camera image. Therefore, for example, the estimation unit 22 may store in advance a correspondence table that correlates the distances of the optical fibers 10A and 10B from the detection unit 21 with the camera coordinates, and perform the above-mentioned position conversion using this correspondence table. The estimation unit 22 may acquire the above-mentioned camera images from each of a plurality of cameras 30 as long as the vicinity of the occurrence position of the traffic accident can be photographed by the plurality of cameras 30.

Then, the estimation unit 22 estimates the situation of the traffic accident occurred on the road R based on the vibration pattern of the vibration caused by the traffic accident that has occurred on the road R detected by the detection unit 21 and the acquired camera image described above.

For example, it is assumed that the estimation unit 22 has estimated a collision accident or the like based on the vibration pattern of vibration caused by a traffic accident. In this case, the estimation unit 22 can further identifies the plate number of the vehicle that caused the collision accident or the like and estimate the situation of the occurrence position of the traffic accident at the occurrence time point of the traffic accident or at least before or after the occurrence of the traffic accident based on the camera image. The situation of the occurrence position of the traffic accident estimated based on the camera image is, for example, the presence or absence of a vehicle that is driving dangerously (for example, aggressive driving, meandering driving, wrong-way driving, driving ignoring traffic signs such as temporary stop, and the like), the presence or absence of a vehicle that is driving inattentively or driving while drowsy, the presence or absence of a traffic congestion, and the like.

In the third example embodiment, the return light received from the optical fibers 10A and 10B or the vibration data obtained by converting the return light and the camera image photographed by the camera 30 are temporarily stored, and then the return light or vibration data and the camera image are read and analyzed to estimate the situation of the traffic accident.

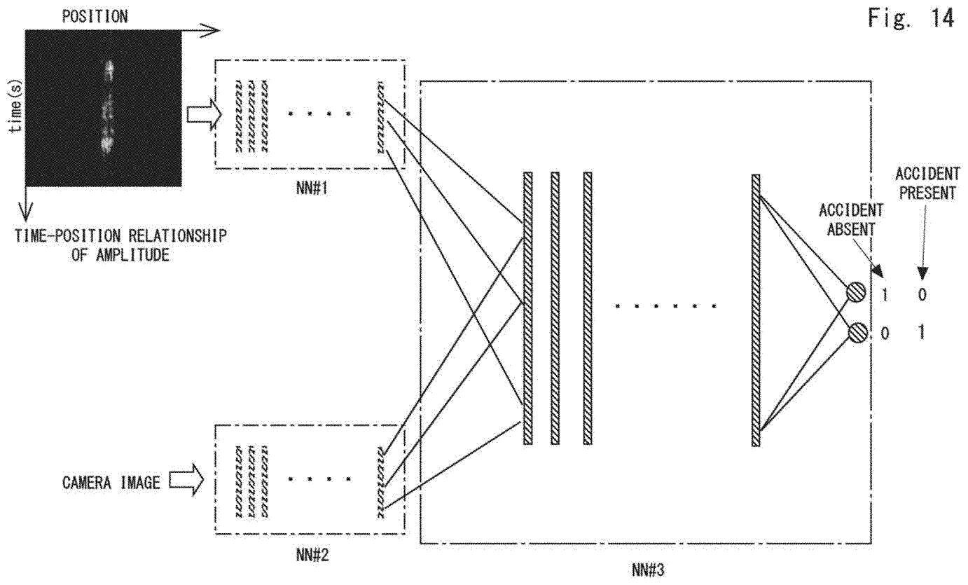

In the third example embodiment, the estimation unit 22 may estimate the situation of a traffic accident that has occurred on the road R using the NN as in the method D of the first example embodiment described above. This method will be described with reference to FIG. 14.

In FIG. 14, an NN to which the vibration data of a specific vehicle traveling on the road R is input, the vibration data representing the correlation between time and position of amplitude is NN #1, an NN to which the camera image of the road R is input is NN #2, and an NN representing the fusion weight of NN #1 to NN #2 is NN #3.

The estimation unit 22 comprehensively determines the two types of information of NN #1 and NN #2 to estimate the presence or absence of the occurrence of a traffic accident. For example, even if the estimation unit 22 estimates that a traffic accident has occurred based on the information of NN #1 detected by the optical fiber 10A, if the information of NN #2 does not show the vehicle in the camera image, it is determined to be an erroneous estimation. As described above, the camera image can also be used as auxiliary information for estimating the presence or absence of the occurrence of a traffic accident.

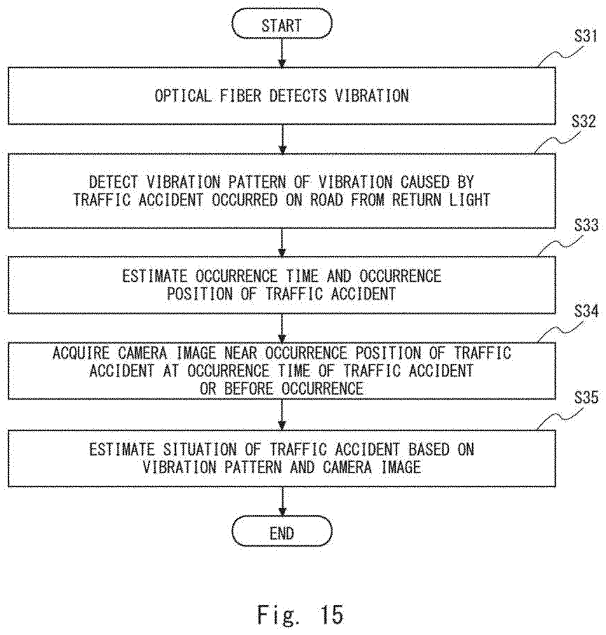

Next, an operation example of the optical fiber sensing system according to the third example embodiment will be described with reference to FIG. 15.

As shown in FIG. 15, the optical fibers 10A and 10B detect the vibration generated on the road R (step S31). The vibration detected by the optical fibers 10A and 10B affects the return light transmitted through the optical fibers 10A and 10B.

Next, the detection unit 21 detects the vibration pattern of the vibration caused by the traffic accident that has occurred on the road R from the return light received from the optical fibers 10A and 10B (step S32).

Next, the estimation unit 22 estimates the occurrence time of the traffic accident based on the time when the return light in which the vibration pattern caused by the traffic accident is detected is received from the optical fibers 10A and 10B. Furthermore, the estimation unit 22 estimates the occurrence position of the traffic accident based on the time difference between the time when the pulsed light is incident on the optical fibers 10A and 10B and the time when the return light in which the vibration pattern caused by the traffic accident is detected is received from the optical fibers 10A and 10B (step S33).

Next, the estimation unit 22 acquires a camera image near the occurrence position of the traffic accident at the occurrence time point of the traffic accident or at least before or after the occurrence of the traffic accident from the camera images photographed by the camera 30 (step S34).

After that, the estimation unit 22 estimates the situation of the traffic accident occurred on the road R based on the vibration pattern of the vibration caused by the traffic accident that has occurred on the road R detected by the detection unit 21, and the camera image near the occurrence position of the traffic accident at the occurrence time point of the traffic accident or at least before or after the occurrence of the traffic accident (step S35).

As described above, according to the third example embodiment, the detection unit 21 detects the vibration pattern of the vibration caused by the traffic accident that has occurred on the road R from the return light received from the optical fibers 10A and 10B. The estimation unit 22 acquires a camera image near the occurrence position of the traffic accident at the occurrence time point of the traffic accident or at least before or after the occurrence of the traffic accident, from the camera images photographed by the camera 30. Then, the estimation unit 22 estimates the situation of the traffic accident that has occurred on the road R based on those vibration pattern and the camera images. As a result, it is possible to grasp the situation of the traffic accident that has occurred on the road R in more detail. Other effects are the same as those in the first example embodiment described above.

The estimation unit 22 may acquire the camera image near the occurrence position of the traffic accident after the occurrence of the traffic accident as follows. For example, when a traffic accident occurs, the estimation unit 22 controls the angle (azimuth angle, elevation angle), zoom magnification, and the like of the camera 30 so as to photograph the vicinity of the occurrence position of the traffic accident, and then acquires the camera images photographed by the camera 30. At this time, a process of converting the occurrence position of the traffic accident to the position on the camera image is required, and this position conversion may be performed by the method using the corresponding table described above.

In the above description, the third example embodiment has been described as having a configuration in which a function is added to the above-mentioned first example embodiment, but as described above, the third example embodiment may have a configuration in which a function is added to the second example embodiment described above. In this case, the estimation unit 22 may estimate the situation of the traffic accident based on the vibration pattern of the vibration caused by the traffic accident that has occurred on the road R detected by the detection unit 21, the vibration pattern of the vibration caused by the traveling state of a vehicle near the occurrence position of the traffic accident on the road R at the occurrence time point of the traffic accident or at least before or after the occurrence of the traffic accident, and the camera image described above.

### Other Example Embodiments

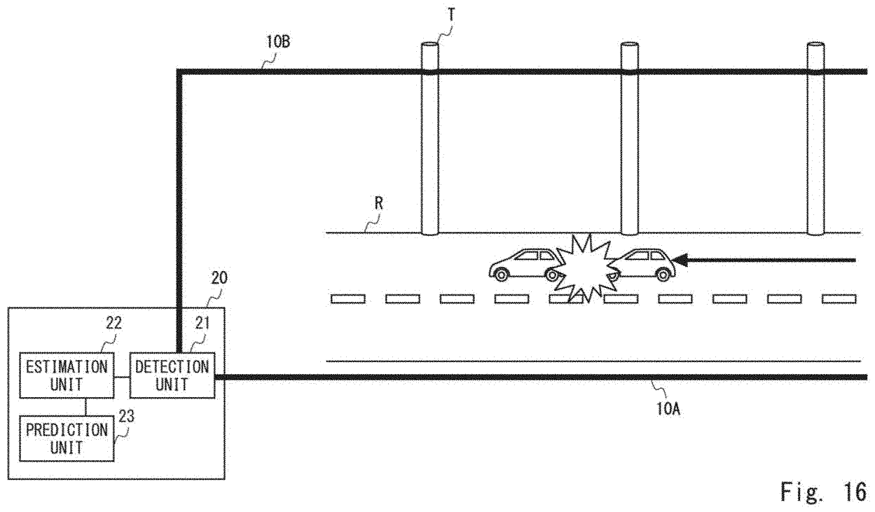

As shown in FIG. 16, the optical fiber sensing device 20 may further include a prediction unit 23.

The prediction unit 23 analyzes the traveling state of the vehicle on the road R and predicts the occurrence of a traffic accident. For example, when the prediction unit 23 detects a vehicle that is driving aggressively or a vehicle whose traveling speed is faster or slower by a threshold value than the surrounding vehicles, it may predict that a traffic accident will occur.

The prediction unit 23 may analyze statistical data of the traveling states of vehicles on the road R to identify a place where a traffic accident is likely to occur. For example, the prediction unit 23 may identify a place where vehicles often make a sudden brake as a place where a traffic accident is likely to occur.

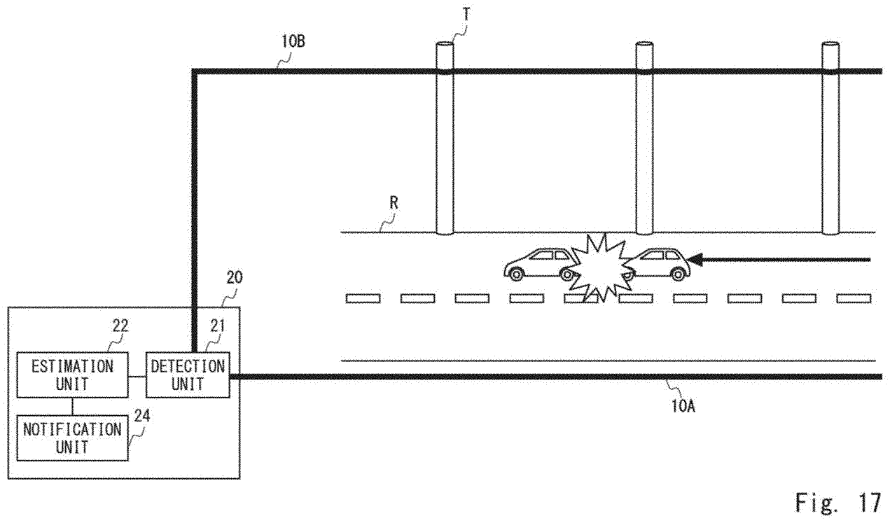

The optical fiber sensing device 20 may further include a notification unit 24 as shown in FIG. 17.

When a traffic accident occurs on the road R, the notification unit 24 notifies that the traffic accident has occurred and also notifies of the situation of the traffic accident estimated by the estimation unit 22. For example, if the road R is a general road, the notification unit 24 notifies the police and the fire department, and if the road R is a highway, the notification unit 24 notifies a highway management company. Further, this notification may be an acoustic output of the corresponding message or a display output.

The notification unit 24 may determine the urgency level according to the situation of the traffic accident, and may change the notification destination and the notification content according to the determined urgency level. For example, the notification unit 24 may increase the urgency level when a person is screaming or when the number of vehicles that caused a traffic accident is large. Further, as shown in Table 1, the notification unit 24 stores in advance a correspondence table in which the urgency level is correlated with the notification destination and the notification content, and may specify the notification destination and notification content corresponding to the urgency level using the correspondence table. In the example of Table 1, the larger the value, the higher the urgency level, and when the urgency level becomes higher, the police are requested to increase the number of police cars.

TABLE 1

| Urgency level | Notification destination and notification content |
|---|---|
| 1 | Request the police to dispatch a police car |
| 2 | Request the police to dispatch multiple police |
| | cars |
| . | . |
| . | . |
| . | . |

The optical fiber sensing device 20 may be configured to include both the prediction unit 23 shown in FIG. 16 and the notification unit 24 shown in FIG. 17. The optical fiber sensing device 20 may be configured to be connected to the camera 30 shown in FIG. 13.

In the examples of FIGS. 1, 13, 16, and 17, the optical fiber sensing device 20 is provided with a plurality of components (the detection unit 21, the estimation unit 22, the prediction unit 23, and the notification unit 24), but there is no limitation thereto. The components provided in the optical fiber sensing device 20 are not limited to being provided in one device, and may be distributed in a plurality of devices.

### Concept of Example Embodiment

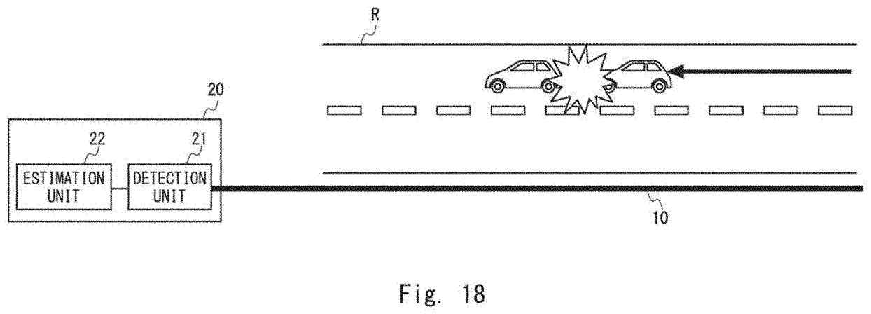

Next, with reference to FIG. 18, a configuration of the optical fiber sensing system conceptually showing the above-described example embodiment will be described.

The optical fiber sensing system shown in FIG. 18 includes an optical fiber 10 and an optical fiber sensing device 20. The optical fiber sensing device 20 includes a detection unit 21 and an estimation unit 22.

The optical fiber 10 is provided along the road R and detects vibration. For example, the optical fiber 10 may be provided in the vicinity of the road R or may be laid on the road R. The optical fiber 10 may be buried under the road R or may be overhead-wired.

The detection unit 21 makes pulsed light incident on the optical fiber 10 and receives reflected light or scattered light generated by the pulsed light being transmitted through the optical fiber 10 as return light via the optical fiber 10. The detection unit 21 detects the vibration pattern of the vibration caused by the traffic accident that has occurred on the road R from the optical signal received from the optical fiber 10.

The estimation unit 22 estimates the situation of a traffic accident that has occurred on the road R based on the vibration pattern of the vibration caused by the traffic accident detected by the detection unit 21.

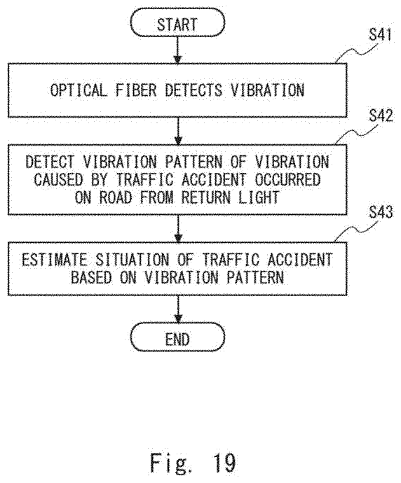

Next, an operation example of the optical fiber sensing system shown in FIG. 18 will be described with reference to FIG. 19.

As shown in FIG. 19, the optical fiber 10 detects the vibration generated on the road R (step S41). The vibration detected in the optical fiber 10 affects the return light transmitted through the optical fiber 10.

Next, the detection unit 21 detects the vibration pattern of the vibration caused by the traffic accident that has occurred on the road R from the return light received from the optical fiber 10 (step S42).

After that, the estimation unit 22 estimates the situation of the traffic accident that has occurred on the road R based on the vibration pattern of the vibration caused by the traffic accident that has occurred on the road R detected by the detection unit 21 (step S43).

By the above operation, it is possible not only to grasp whether or not a traffic accident has occurred on the road R, but also to grasp the situation of the traffic accident that has occurred on the road R.

<Hardware Configuration of Optical Fiber Sensing Device>

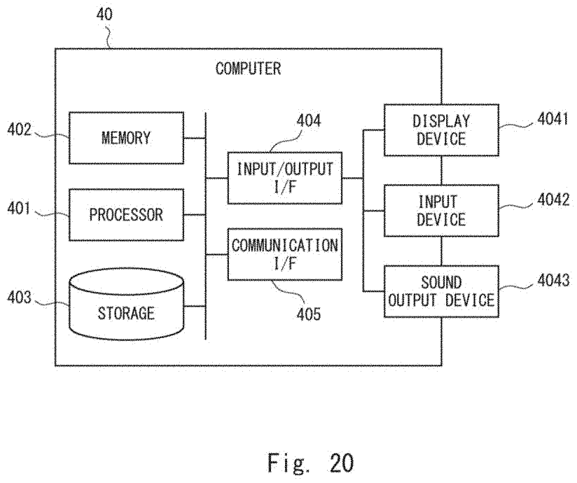

Next, with reference to FIG. 20, a hardware configuration example of a computer 40 that realizes the optical fiber sensing device 20 will be described below. Here, a case where the optical fiber sensing device 20 having the configuration of the first example embodiment described above is realized will be described as an example.

As shown in FIG. 20, the computer 40 includes a processor 401, a memory 402, a storage 403, an input/output interface (input/output I/F) 404, a communication interface (communication I/F) 405, and the like. The processor 401, the memory 402, the storage 403, the input/output interface 404, and the communication interface 405 are connected by a data transmission line for transmitting and receiving data to and from each other.

The processor 401 is, for example, an arithmetic processing unit such as a CPU (Central Processing Unit) or a GPU (Graphics Processing Unit). The memory 402 is, for example, a memory such as a RAM (Random Access Memory) or a ROM (Read Only Memory). The storage 403 is, for example, a storage device such as an HDD (Hard Disk Drive), an SSD (Solid State Drive), or a memory card. The storage 403 may be a memory such as a RAM or a ROM.

The storage 403 stores programs that realize the functions of the components (the detection unit 21 and the estimation unit 22) included in the optical fiber sensing device 20. By executing each of these programs, the processor 401 realizes the functions of the components included in the optical fiber sensing device 20. Here, when executing each of the above programs, the processor 401 may read these programs onto the memory 402 and then execute the programs, or may execute the programs without reading them onto the memory 402. The memory 402 and the storage 403 also play a role of storing information and data stored by the components included in the optical fiber sensing device 20.

In addition, the above-mentioned programs can be stored using various types of non-transitory computer-readable medium and supplied to a computer (including the computer 40). Non-transitory computer-readable media include various types of tangible storage media. Examples of non-transitory computer-readable media include magnetic recording media (for example, flexible discs, magnetic tapes, hard disk drives), optomagnetic recording media (for example, optomagnetic discs), CD-ROMs (Compact Disc-ROMs), CD-R (CD-Recordable), CD-R/W (CD-ReWritable), semiconductor memory (for example, mask ROM, PROM (Programmable ROM), EPROM (Erasable PROM), flash ROM, and RAM. The programs may be supplied to the computer by various types of transitory computer-readable media. Examples of transitory computer-readable media include electrical signals, optical signals, and electromagnetic waves. The transitory computer-readable media can supply the program to the computer via a wired communication path such as an electric wire and an optical fiber, or a wireless communication path.

The input/output interface 404 is connected to a display device 4041, an input device 4042, a sound output device 4043, and the like. The display device 4041 is a device that displays a screen corresponding to drawing data processed by the processor 401, such as an LCD (Liquid Crystal Display), a CRT (Cathode Ray Tube) display, and a monitor. The input device 4042 is a device that receives an operator's operation input, and is, for example, a keyboard, a mouse, a touch sensor, and the like. The display device 4041 and the input device 4042 may be integrated and realized as a touch panel. The sound output device 4043 is a device such as a speaker that acoustically outputs sound corresponding to acoustic data processed by the processor 401.

The communication interface 405 transmits and receives data to and from an external device. For example, the communication interface 405 communicates with an external device via a wired communication path or a wireless communication path.

Although the present disclosure has been described with reference to the example embodiments, the present disclosure is not limited to the above-described example embodiments. Various changes that can be understood by those skilled in the art can be made to the structure and details of the present disclosure within the scope of the present disclosure.

For example, the above-described example embodiments may be used in combination in part or in whole.

Further, a part or all of the above example embodiments may be described as in the following supplementary notes, but the present invention is not limited to the following.

(Supplementary Note 1)

An optical fiber sensing system comprising:

an optical fiber provided along a road to detect vibrations;

a detection unit configured to detect a vibration pattern of a vibration caused by a traffic accident that has occurred on the road from optical signals received from the optical fiber; and

an estimation unit configured to estimate a situation of the traffic accident based on the vibration pattern.

(Supplementary Note 2)

The optical fiber sensing system according to Supplementary note 1, wherein the estimation unit estimates an occurrence time of the traffic accident based on a time when the optical signal in which the vibration pattern is detected is received from the optical fiber.

(Supplementary Note 3)

The optical fiber sensing system according to Supplementary note 2, wherein

the detection unit receives the optical signal for incident light incident on the optical fiber, and

the estimation unit estimates an occurrence position of the traffic accident based on a time difference between a time when the incident light is incident on the optical fiber and the time when the optical signal in which the vibration pattern is detected is received from the optical fiber.

(Supplementary Note 4)

The optical fiber sensing system according to Supplementary note 3, wherein

the vibration pattern further includes a vibration pattern of a vibration caused by a traveling state of a vehicle near the occurrence position of the traffic accident on the road at an occurrence time point of the traffic accident or before an occurrence of the traffic accident, and

the estimation unit estimates the situation of the traffic accident based on the vibration pattern.

(Supplementary Note 5)

The optical fiber sensing system according to Supplementary note 3 or 4, wherein

the vibration pattern further includes a vibration pattern of a vibration caused by a traveling state of a vehicle near the occurrence position of the traffic accident on the road after an occurrence of the traffic accident, and

the estimation unit estimates the situation of the traffic accident based on the vibration pattern.

(Supplementary Note 6)

The optical fiber sensing system according to Supplementary note 3, further comprising a camera configured to photograph the road,

wherein the estimation unit is configured to:

acquire a camera image near the occurrence position of the traffic accident on the road at an occurrence time point of the traffic accident or at least before or after an occurrence of the traffic accident from camera images photographed by the camera; and

estimate the situation of the traffic accident based on the vibration pattern and the acquired camera image.

(Supplementary Note 7)

The optical fiber sensing system according to Supplementary note 4 or 5, further comprising a camera configured to photograph the road,

wherein the estimation unit is configured to:

acquire a camera image near the occurrence position of the traffic accident on the road at an occurrence time point of the traffic accident or at least before or after the occurrence of the traffic accident from camera images photographed by the camera; and

estimate the situation of the traffic accident based on the vibration pattern and the acquired camera image.

(Supplementary Note 8)

The optical fiber sensing system according to any one of Supplementary notes 1 to 7, wherein the optical fiber includes:

a first optical fiber buried under the road; and

a second optical fiber that is overhead-wired along the road.

(Supplementary Note 9)

A road monitoring method by an optical fiber sensing system, comprising:

allowing an optical fiber provided along a road to detect vibrations;

detecting a vibration pattern of a vibration caused by a traffic accident that has occurred on the road from optical signals received from the optical fiber; and

estimating a situation of the traffic accident based on the vibration pattern.

(Supplementary Note 10)

The road monitoring method according to Supplementary note 9, wherein the estimating involves estimating an occurrence time of the traffic accident based on a time when the optical signal in which the vibration pattern is detected is received from the optical fiber.

(Supplementary Note 11)

The road monitoring method according to Supplementary note 10, wherein

the detecting involves receiving the optical signal for incident light incident on the optical fiber, and

the estimating involves estimating an occurrence position of the traffic accident based on a time difference between a time when the incident light is incident on the optical fiber and a time when the optical signal in which the vibration pattern is detected is received from the optical fiber.

(Supplementary Note 12)

The road monitoring method according to Supplementary note 11, wherein

the vibration pattern further includes a vibration pattern of a vibration caused by a traveling state of a vehicle near the occurrence position of the traffic accident on the road at an occurrence time point of the traffic accident or before an occurrence of the traffic accident, and

the estimating involves estimating the situation of the traffic accident based on the vibration pattern.

(Supplementary Note 13)

The road monitoring method according to Supplementary note 11 or 12, wherein

the vibration pattern further includes a vibration pattern of a vibration caused by a traveling state of a vehicle near the occurrence position of the traffic accident on the road after an occurrence of the traffic accident, and

the estimating involves estimating the situation of the traffic accident based on the vibration pattern.

(Supplementary Note 14)

The road monitoring method according to Supplementary note 11, wherein the estimating involves:

acquiring a camera image near the occurrence position of the traffic accident on the road at an occurrence time point of the traffic accident or at least before or after an occurrence of the traffic accident from camera images photographed by a camera configured to photograph the road; and

estimating the situation of the traffic accident based on the vibration pattern and the acquired camera image.

(Supplementary Note 15)

The road monitoring method according to Supplementary note 12 or 13, wherein the estimating involves:

acquiring a camera image near the occurrence position of the traffic accident on the road at an occurrence time point of the traffic accident or at least before or after the occurrence of the traffic accident from camera images photographed by a camera configured to photograph the road; and

estimating the situation of the traffic accident based on the vibration pattern and the acquired camera image.

(Supplementary Note 16)

The road monitoring method according to any one of Supplementary notes 9 to 15, wherein the optical fiber includes:

a first optical fiber buried under the road; and

a second optical fiber that is overhead-wired along the road.

(Supplementary Note 17)

An optical fiber sensing device comprising:

a detection unit configured to detect a vibration pattern of a vibration caused by a traffic accident that has occurred on a road from optical signals received from an optical fiber provided along the road to detect vibrations; and

an estimation unit configured to estimate a situation of the traffic accident based on the vibration pattern.

(Supplementary Note 18)

The optical fiber sensing device according to Supplementary note 17, wherein the estimation unit estimates an occurrence time of the traffic accident based on a time when the optical signal in which the vibration pattern is detected is received from the optical fiber.

(Supplementary Note 19)

The optical fiber sensing device according to Supplementary note 18, wherein

the detection unit receives the optical signal for incident light incident on the optical fiber, and

the estimation unit estimates an occurrence position of the traffic accident based on a time difference between a time when the incident light is incident on the optical fiber and the time when the optical signal in which the vibration pattern is detected is received from the optical fiber.

(Supplementary Note 20)

The optical fiber sensing device according to Supplementary note 19, wherein

the vibration pattern further includes a vibration pattern of a vibration caused by a traveling state of a vehicle near the occurrence position of the traffic accident on the road at an occurrence time point of the traffic accident or before an occurrence of the traffic accident, and

the estimation unit estimates the situation of the traffic accident based on the vibration pattern.

(Supplementary Note 21)

The optical fiber sensing device according to Supplementary note 19 or 20, wherein

the vibration pattern further includes a vibration pattern of a vibration caused by a traveling state of a vehicle near the occurrence position of the traffic accident on the road after an occurrence of the traffic accident, and

the estimation unit estimates the situation of the traffic accident based on the vibration pattern.

(Supplementary Note 22)

The optical fiber sensing device according to Supplementary note 19, wherein the estimation unit is configured to:

acquire a camera image near the occurrence position of the traffic accident on the road at an occurrence time point of the traffic accident or at least before or after an occurrence of the traffic accident from camera images photographed by a camera configured to photograph the road; and

estimate the situation of the traffic accident based on the vibration pattern and the acquired camera image.

(Supplementary Note 23)

The optical fiber sensing device according to Supplementary note 20 or 21, wherein the estimation unit is configured to:

acquire a camera image near the occurrence position of the traffic accident on the road at an occurrence time point of the traffic accident or at least before or after the occurrence of the traffic accident from camera images photographed by a camera configured to photograph the road; and

estimate the situation of the traffic accident based on the vibration pattern and the acquired camera image.

### REFERENCE SIGNS LIST

10, 10A, 10B OPTICAL FIBER
20 OPTICAL FIBER SENSING DEVICE
21 DETECTION UNIT
22 ESTIMATION UNIT
23 PREDICTION UNIT
24 NOTIFICATION UNIT
30 CAMERA
40 COMPUTER
401 PROCESSOR
402 MEMORY
403 STORAGE
404 INPUT/OUTPUT INTERFACE
4041 DISPLAY DEVICE
4042 INPUT DEVICE
4043 SOUND OUTPUT DEVICE
405 COMMUNICATION INTERFACE
R ROAD
T UTILITY POLE

What is claimed is:

1. An optical fiber sensing system comprising:
an optical fiber provided along a road to detect vibrations;
a detection unit configured to detect a vibration pattern of a vibration caused by a traffic accident that has occurred on the road from optical signals received from the optical fiber; and
an estimation unit configured to estimate a situation of the traffic accident based on the vibration pattern.

2. The optical fiber sensing system according to claim 1, wherein the estimation unit estimates an occurrence time of the traffic accident based on a time when the optical signal in which the vibration pattern is detected is received from the optical fiber.

3. The optical fiber sensing system according to claim 2, wherein
the detection unit receives the optical signal for incident light incident on the optical fiber, and
the estimation unit estimates an occurrence position of the traffic accident based on a time difference between a time when the incident light is incident on the optical fiber and the time when the optical signal in which the vibration pattern is detected is received from the optical fiber.

4. The optical fiber sensing system according to claim 3, wherein
the vibration pattern further includes a vibration pattern of a vibration caused by a traveling state of a vehicle near the occurrence position of the traffic accident on the road at an occurrence time point of the traffic accident or before an occurrence of the traffic accident, and
the estimation unit estimates the situation of the traffic accident based on the vibration pattern.

5. The optical fiber sensing system according to claim 3, wherein
the vibration pattern further includes a vibration pattern of a vibration caused by a traveling state of a vehicle near the occurrence position of the traffic accident on the road after an occurrence of the traffic accident, and
the estimation unit estimates the situation of the traffic accident based on the vibration pattern.

6. The optical fiber sensing system according to claim 3, further comprising a camera configured to photograph the road,
wherein the estimation unit is configured to:
acquire a camera image near the occurrence position of the traffic accident on the road at an occurrence time point of the traffic accident or at least before or after an occurrence of the traffic accident from camera images photographed by the camera; and
estimate the situation of the traffic accident based on the vibration pattern and the acquired camera image.

7. The optical fiber sensing system according to claim 4, further comprising a camera configured to photograph the road,
wherein the estimation unit is configured to:
acquire a camera image near the occurrence position of the traffic accident on the road at an occurrence time point of the traffic accident or at least before or after the occurrence of the traffic accident from camera images photographed by the camera; and
estimate the situation of the traffic accident based on the vibration pattern and the acquired camera image.

8. The optical fiber sensing system according to claim 1, wherein the optical fiber includes:
a first optical fiber buried under the road; and
a second optical fiber that is overhead-wired along the road.

9. A road monitoring method by an optical fiber sensing system, comprising:
allowing an optical fiber provided along a road to detect vibrations;
detecting a vibration pattern of a vibration caused by a traffic accident that has occurred on the road from optical signals received from the optical fiber; and
estimating a situation of the traffic accident based on the vibration pattern.

10. The road monitoring method according to claim 9, wherein the estimating involves estimating an occurrence time of the traffic accident based on a time when the optical signal in which the vibration pattern is detected is received from the optical fiber.

11. The road monitoring method according to claim 10, wherein
the detecting involves receiving the optical signal for incident light incident on the optical fiber, and
the estimating involves estimating an occurrence position of the traffic accident based on a time difference between a time when the incident light is incident on the optical fiber and a time when the optical signal in which the vibration pattern is detected is received from the optical fiber.

12. The road monitoring method according to claim 11, wherein
the vibration pattern further includes a vibration pattern of a vibration caused by a traveling state of a vehicle near the occurrence position of the traffic accident on the road at an occurrence time point of the traffic accident or before an occurrence of the traffic accident, and
the estimating involves estimating the situation of the traffic accident based on the vibration pattern.

13. The road monitoring method according to claim 11, wherein
the vibration pattern further includes a vibration pattern of a vibration caused by a traveling state of a vehicle near the occurrence position of the traffic accident on the road after an occurrence of the traffic accident, and
the estimating involves estimating the situation of the traffic accident based on the vibration pattern.

14.-16. (canceled)

17. An optical fiber sensing device comprising:
a detection unit configured to detect a vibration pattern of a vibration caused by a traffic accident that has occurred on a road from optical signals received from an optical fiber provided along the road to detect vibrations; and
an estimation unit configured to estimate a situation of the traffic accident based on the vibration pattern.

18. The optical fiber sensing device according to claim 17, wherein the estimation unit estimates an occurrence time of the traffic accident based on a time when the optical signal in which the vibration pattern is detected is received from the optical fiber.

19. The optical fiber sensing device according to claim 18, wherein
the detection unit receives the optical signal for incident light incident on the optical fiber, and
the estimation unit estimates an occurrence position of the traffic accident based on a time difference between a time when the incident light is incident on the optical fiber and the time when the optical signal in which the vibration pattern is detected is received from the optical fiber.

20. The optical fiber sensing device according to claim 19, wherein
the vibration pattern further includes a vibration pattern of a vibration caused by a traveling state of a vehicle near the occurrence position of the traffic accident on the road at an occurrence time point of the traffic accident or before an occurrence of the traffic accident, and
the estimation unit estimates the situation of the traffic accident based on the vibration pattern.

21. The optical fiber sensing device according to claim 19, wherein
the vibration pattern further includes a vibration pattern of a vibration caused by a traveling state of a vehicle near the occurrence position of the traffic accident on the road after an occurrence of the traffic accident, and
the estimation unit estimates the situation of the traffic accident based on the vibration pattern.

22. The optical fiber sensing device according to claim 19, wherein the estimation unit is configured to:
acquire a camera image near the occurrence position of the traffic accident on the road at an occurrence time point of the traffic accident or at least before or after an occurrence of the traffic accident from camera images photographed by a camera configured to photograph the road; and
estimate the situation of the traffic accident based on the vibration pattern and the acquired camera image.

23. The optical fiber sensing device according to claim 20, wherein the estimation unit is configured to:
acquire a camera image near the occurrence position of the traffic accident on the road at an occurrence time point of the traffic accident or at least before or after the occurrence of the traffic accident from camera images photographed by a camera configured to photograph the road; and
estimate the situation of the traffic accident based on the vibration pattern and the acquired camera image.
